(19) United States
(12) Patent Application Publication
(10) Pub. No.: US 2021/0040908 A1
(43) Pub. Date: Feb. 11, 2021

(54) DECELERATION CYLINDER CUT OFF AND TURBOCHARGER ROTATIONAL SPEED MANAGEMENT

(71) Applicant: Tula Technology, Inc., San Jose, CA (US)

(72) Inventor: Vijay Srinivasan, Farmington Hills, MI (US)

(21) Appl. No.: 17/077,887

(22) Filed: Oct. 22, 2020

Related U.S. Application Data
(63) Continuation-in-part of application No. 16/373,364, filed on Apr. 2, 2019, now Pat. No. 10,823,029.

(51) Int. Cl. F02D 41/12; F02D 13/06; F02B 37/24

(52) U.S. Cl. CPC F02D 41/12; F02B 37/24; F02D 13/06

(57) ABSTRACT

Methods, systems, and devices for deceleration firing fraction/deceleration cylinder cut off (DCCO) control with turbocharger rotational speed feedback are disclosed herein. An engine controller in a vehicle for controlling an internal combustion engine, the controller configured to: determine a threshold rotational speed for a turbocharger, determine a target firing fraction that will allow the engine to maintain a speed above the threshold, initiate a DCCO process wherein the DCCO process reduces flow of exhaust to the turbocharger and thereby the turbocharger rotational speed decreases, receive speed data of the turbocharger rotational speed, and analyze the received data to determine when to switch the firing fraction of the engine from an original firing fraction to the determined target firing fraction to maintain the rotational speed of the turbocharger above the threshold.

### CROSS REFERENCE TO RELATED APPLICATIONS

This application is a Continuation-in-Part of U.S. application Ser. No. 16/373,364 filed Apr. 2, 2019. The above listed application is incorporated by reference herein in its entirety for all purposes.

### FIELD OF THE INVENTION

Methods, systems, and devices for deceleration cylinder cut off and turbocharger rotational speed management are disclosed herein.

### BACKGROUND

Most vehicles in operation today are powered by internal combustion (IC) engines. Internal combustion engines typically have multiple working chambers (i.e., cylinders) where combustion occurs. The power generated by the engine depends on a combination of (a) the number of cylinders and (b) the amount of fuel and air that is delivered to each cylinder. During everyday driving, the engine of a vehicle typically operates over a wide range of torque demands and operating speeds to meet varying driving conditions.

There are two common types of IC engines: spark ignition (SI) engines and compression ignition engines. Both engine types typically use a cylinder as the working chamber with a piston that reciprocates within the cylinder forming an enclosed volume with variable size depending on the piston location. Air is inducted from an intake manifold into one or more cylinders through an intake valve or valves by forcing the piston to expand the enclosed volume. The inducted air is then compressed by the piston moving so as to contract the enclosed volume. Combustion occurs within a contained volume of the cylinder at or near its minimum size. Expanding combustion gases push the piston outward expanding the enclosed volume and performing useful work. The piston in turn forces out exhaust gases from the enclosed volume into an exhaust manifold through one or more exhaust valve(s).

With SI engines, combustion is initiated by a spark. That is, an air-fuel mixture is contained within the cylinder(s) of an engine and then a spark, typically from a spark-plug, is used to ignite the mixture.

Compression engines, on the other hand, rely on the pressure and temperature of the air-fuel mixture, not a spark, to initiate combustion. An air-fuel mixture is contained within the cylinder and combustion is caused by elevation of the mixture temperature by mechanical compression, resulting in spontaneous combustion of the fuel.

The air-fuel ratio in a cylinder is an important measure with both SI and compression-ignition type engines. If exactly enough air is provided to completely burn all the fuel without any remaining oxygen, the ratio is known as “stoichiometric”.

Ratios lower than stoichiometric are considered “rich”, meaning the ratio defines more fuel than can be burned by the provided amount of air. Rich mixtures can generate more power and burn cooler, but at the expense of efficiency. Ratios higher than stoichiometric, on the other hand, are considered “lean”, meaning the ratio defines an air-fuel mixture with more oxygen than can be combusted by the fuel.

Internal combustion engines create byproducts that need to be removed from the exhaust gas generated from the combustion process. Accordingly, both spark ignition and compression ignition engines require emission control systems including one or more aftertreatment elements to limit emissions of undesirable pollutants that are combustion byproducts.

Additionally, fuel efficiency of internal combustion engines can be substantially improved by varying the engine displacement. This allows for the full torque to be available when required yet can significantly reduce pumping losses and improve thermal efficiency by using a smaller displacement when full torque is not required.

The most common method, today, of implementing a variable displacement engine is to deactivate a group of cylinders substantially simultaneously. Commercially available variable displacement engines available today typically support only two or at most three displacements.

Another engine control approach that varies the effective displacement of an engine is referred to as “skip fire” engine control. In general, skip fire engine control contemplates selectively skipping the firing of certain cylinders during selected firing opportunities. Thus, a particular cylinder may be fired during one engine cycle and then skipped during the next engine cycle and selectively skipped or fired during the next.

From an engine cycle perspective, skip fire control may have different sets of cylinders fired during sequential engine cycles to generate the same average torque, whereas variable displacement operation deactivates the same set of cylinders. In this manner, even finer control of the effective engine displacement is possible. For example, firing every third cylinder in a 4-cylinder engine would provide an effective reduction to ⅓^{rd} of the full engine displacement, which is a fractional displacement that is not obtainable by simply deactivating a set of cylinders.

### BRIEF DESCRIPTION OF THE DRAWINGS

The invention and the advantages thereof, may best be understood by reference to the following description taken in conjunction with the accompanying drawings in which:

FIG. 1A is a schematic diagram of a representative engine exhaust system for an example compression ignition engine.

FIG. 1B is a schematic diagram of an alternative representative engine exhaust system for an example internal combustion engine.

FIG. 2 is a plot of exhaust gas temperature versus engine load for an example internal combustion engine.

FIG. 3 is a schematic diagram of an engine controller for the example internal combustion engine, according to an embodiment of the present disclosure.

FIG. 4 is a logic diagram of a skip fire controller arranged to operate the example internal combustion engine, according to an embodiment of the present disclosure.

FIG. 5 is a schematic diagram of an engine with a turbocharger under different firing density modes, according to an embodiment of the present disclosure.

FIG. 6 is a schematic diagram for a valve deactivation controller, according to an embodiment of the present disclosure.

FIG. 7 a diagram illustrating modulation of exhaust gas temperature by using cylinder deactivation during skip fire operation of the example internal combustion engine, according to an embodiment of the present disclosure.

FIG. 8 is a logic flow diagram illustrating prioritization of inputs provided to the valve deactivation controller, according to an embodiment of the present disclosure.

FIG. 9 is a flow chart illustrating steps for operating an internal combustion engine with separately defined firing and pumping density signals during transitions from a first firing density to a target firing density, in accordance with an embodiment of the disclosure.

FIG. 10 provides two graphs that illustrate one method for maintaining the turbocharger rotational speed above a threshold, according to an embodiment of the present disclosure.

FIG. 11 provides two graphs that illustrate another method for maintaining the turbocharger rotational speed above a threshold, according to an embodiment of the present disclosure.

FIG. 12 provides two graphs that illustrate another method for maintaining the turbocharger rotational speed above a threshold, according to an embodiment of the present disclosure.

FIG. 13 provides a method of managing DCCO and turbocharger rotational speed, according to embodiments of the present disclosure.

FIG. 14 illustrates a variable geometry turbocharger which can be used in conjunction with embodiments of the present disclosure, wherein the variable geometry is in a closed state.

FIG. 15 illustrates a variable geometry turbocharger which can be used in conjunction with embodiments of the present disclosure, wherein the variable geometry is in an open state.

In the drawings, like reference numerals are sometimes used to designate like structural elements. It should also be appreciated that the depictions in the figures are diagrammatic and not to scale.

### DETAILED DESCRIPTION

As discussed above, methods, systems, and devices for deceleration cylinder cut off and turbocharger rotational speed management are disclosed herein. For example, for an engine controller in a vehicle for controlling an internal combustion engine, the controller can be configured to: determine a threshold rotational speed for a turbocharger, determine a target firing fraction that will allow the engine to maintain a turbocharger speed above the threshold, initiate a deceleration cylinder cut off (DCCO) process wherein the DCCO process reduces flow of exhaust to the turbocharger and thereby the turbocharger rotational speed decreases, receive speed data of the turbocharger rotational speed, and analyze the received data to determine when to switch the firing fraction of the engine from an original firing fraction to the determined target firing fraction to maintain the rotational speed of the turbocharger above the threshold. Skip fire and other variable displacement technologies can be beneficial to embodiments of the present disclosure in some implementations and, as such, those technologies are discussed in some detail herein.

### Skip Fire Engine Control

Skip fire engine control contemplates selectively skipping the firing of certain cylinders during selected firing opportunities. Thus, for a given effective engine displacement that is less than the full displacement of the engine, a particular cylinder may be successively fired during one firing opportunity, skipped during the next firing opportunity, and then selectively skipped or fired during the next firing opportunity. The firing sequence may be expressed as a firing density, which indicates a ratio of fired firing opportunities to total firing opportunities. Firing density may be expressed as a fraction, a percentage, or in some other manner. With skip fire, much finer engine control is possible than by using only a fixed set of deactivated cylinders. Various approaches of this kind are described in co-assigned U.S. patent application Ser. No. 13/654,244, which is incorporated herein in its entirety for all purposes.

During normal driving, an engine typically must operate over a wide range of engine speeds and engine loads. To meet these changing operating conditions, a skip fire controlled engine may transition between various firing densities. For instance, a commercially available skip fire controller that provides for seventeen (17) different firing densities, each indicative of a different reduced effective engine displacement, is available.

In contrast, with conventional variable displacement, a set of one or more cylinders are continuously fired, while a second set of one or more different cylinders are continually deactivated or skipped. For example, an 8-cylinder conventional variable displacement engine may deactivate blocks of cylinders (i.e., 2, 4, or 6 cylinders) so that it is operating using only the remaining (i.e., 6, 4, or 2) cylinders. With significantly more firing densities available, skip fire offers significantly more refined engine control compared to conventional variable displacement engine control.

Skip fire control generally operates based on firing opportunities, independent of any particular cylinder firing pattern. For each engine cycle, an internal combustion engine with a plurality cylinders operates in a predefined firing opportunity sequence. With a 6-cylinder engine, a cylinder firing opportunity sequence, for example, may be 1, 5, 3, 6, 2, and 4, where the numbers 1 through 6 correspond to a physical location of each cylinder in the engine. In skip fire control, a skip fire pattern or firing sequence can start or end on any particular cylinder.

Dynamic Skip Fire (DSF) Engine Control

With certain implementations of skip fire engine control, a decision to fire or not fire a given cylinder of an engine is made dynamically, meaning on a firing opportunity-by-firing opportunity basis. In other words, prior to each successive firing opportunity, a decision is made to either fire or skip the firing opportunity. In various embodiments, the firing sequence is determined on a firing opportunity by firing opportunity basis by using a sigma delta, or equivalently a delta sigma, converter. Such a skip fire control system may be defined as dynamic skip fire control. For more details on DSF, see U.S. Pat. Nos. 7,849,835, 9,086,020 and 9,200,575, and U.S. application Ser. No. 14/638,908, each incorporated by reference herein for all purposes.

Skip fire engine control, including DSF, can offer various advantages, including substantial improvements in fuel economy for spark ignition engines where pumping losses may be reduced by operating at higher average manifold absolute pressure (MAP) levels. With compression ignition engines, skip fire control provides a means to control the engine exhaust gas temperature over a wide range of engine operating conditions. In particular, skip fire control may be used to modulate exhaust gas temperatures within a range where aftertreatment emission control systems can efficiently reduce tailpipe emissions. Various approaches of this kind are described in co-assigned U.S. patent application Ser. No. 15/347,562, which is incorporated herein in its entirety for all purposes. Use of skip fire control can also offer greater than a twenty percent (20%) improvement in fuel consumption efficiency in compression ignition engines at light loads, for example, loads less than 10% of the engine's maximum output, in some implementations.

Exhaust Systems

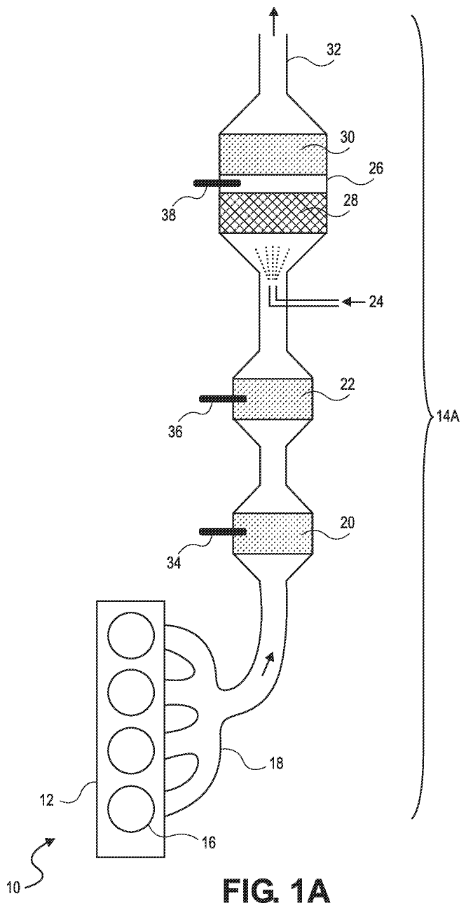

FIG. 1A is a schematic diagram of an example system 10 including an engine 12 and aftertreatment system 14A. In this embodiment, the particulate filter 20 is situated upstream of the reducing catalytic converter 26 and oxidizing catalytic converter 22. Such as arrangement may be particularly applicable to a gasoline-fueled lean burn engine.

The engine 12 includes a plurality of cylinders 16 where combustion occurs. In the embodiment shown, the engine 12 includes four (4) cylinders 16. It should be understood that the engine 12 as illustrated is merely example and may include either fewer or more cylinders 16. In addition, the engine 12 can be a compression ignition engine, a spark-ignition (SI) engine, an engine that combines spark ignition with compression ignition, or an engine that ignites the air fuel mixture with a different technology.

For the sake of simplicity, the discussion below of the operation of the engine 12 is largely within the context of a compression ignition engine, such as a Diesel engine. It should be understood, however, that many of the features discussed below are equally applicable to other types of engines, such as SI engines.

The exhaust system 12 includes an exhaust manifold 18 and several apparatuses 20, 22, and 26 that treat the exhaust gas before it exits the exhaust system via the tailpipe 32. For example, the system can include a reducing catalytic converter 26. The reducing catalytic converter 26 may use two catalysts. A first catalyst 28 transforms urea introduced by a reducing agent injection system 24 to ammonia and transforms nitrous oxides and ammonia into molecular nitrogen and water. A second catalyst 30 utilizes excess ammonia, which may slip through the first catalyst 28, to continue to reduce residual NOx. After passing through the reducing catalytic converter 26, the exhaust stream leaves the exhaust system 14A, via tailpipe 32, and goes into the environment.

The exhaust system 14A may additionally include one or more temperature sensors. Such temperature sensors may include (a) a temperature sensor 34 to monitor the temperature of the particulate filter 20, (b) a temperature sensor 36 to monitor the temperature of oxidizing catalytic converter 22, and (c) a temperature sensor 38 to monitor the temperature of the reducing catalytic converter 26.

Referring to FIG. 1B, the system 10 including the engine 12 and an alternative representative exhaust system 14B is shown. With this arrangement, the particulate filter 20 is placed downstream of the reducing catalytic converter 26. Otherwise, the exhaust systems 14A and 14B are essentially the same.

The arrangement of the exhaust system of 14B may be advantageous when the particulate filter 20 needs to be regularly cleaned by an active process that raises its temperature to burn out accumulated soot. Those temperatures commonly reach 500 C to 600 C. The active cleaning process may include intentionally introducing non-combusted hydrocarbons into the exhaust stream and oxidizing them in the oxidizing catalytic converter 22 to produce heat. By positioning the oxidizing catalytic converter 22 upstream from the particulate filter 20, the temperature within the particulate filter 20 may be actively controlled during the cleaning process.

It should be noted that the particular order of the various aftertreatment elements shown in FIG. 1A and FIG. 1B are merely examples and should not be construed as limiting. The order of the various aftertreatment elements described herein, as well as additional aftertreatment elements that may be used, may widely vary to meet operating conditions, regulatory requirements and/or other objectives.

It also should be noted that the exhaust systems 14A and 14B may also include other types of sensors besides temperature sensors. Such sensors may include (not illustrated), for example, oxygen sensors placed before and after the oxidizing catalytic converter 22, and a NOₓ sensor situated downstream from the reducing catalytic converter 26.

It should further be noted that various other features and elements not shown in FIGS. 1A and 1B may be situated between the engine and the aftertreatment elements of exhaust systems 14A and 14B. Such elements may include, but are not limited to, an exhaust gas recirculation system (EGR), a turbine to power a turbocharger, and a waste gate to control exhaust gas flow through the turbine, etc.

### Exhaust System Operating Temperatures

The exhaust stream will generally be at its hottest temperature as it passes from the engine 12 through the exhaust manifold 18. As the exhaust stream passes through the subsequent elements of the exhaust system 14A/14B, the gases tend to cool from one stage to the next. The aftertreatment elements 20, 22, and 26 are, therefore, typically arranged in the order requiring the highest to lowest operating temperatures. For example, the exhaust gases passing through the particulate filter 20 are hotter than that passing through to the downstream elements 20 and 26 in FIG. 1A. In the arrangement of FIG. 1B the gases passing through the reducing catalytic converter 26 are hotter than that of the downstream particulate filter 20. It should be appreciated that exothermic chemical reactions may occur in any aftertreatment element, which may raise the temperature of the aftertreatment element and any other downstream elements.

In order for the aftertreatment systems 14A and 14B to properly function, the elements 20, 22, and 26 each need to operate within a specified elevated temperature range. In a non-exclusive embodiment, the representative operating range for the reducing catalyst 26 is in the approximate range of 200° to 400° C. It should be understood that these temperature values are approximate and not absolute. Each may vary, for example, within ten percent (+/−10%) from 200° C. and 400° C. If the reducing catalytic converter 26 (including reducing catalytic converters 28, 30) is last in line for a given aftertreatment system, the upstream elements including the particulate filter 20 and the oxidizing catalyst 22, regardless of their order, will typically operate at somewhat higher temperature ranges.

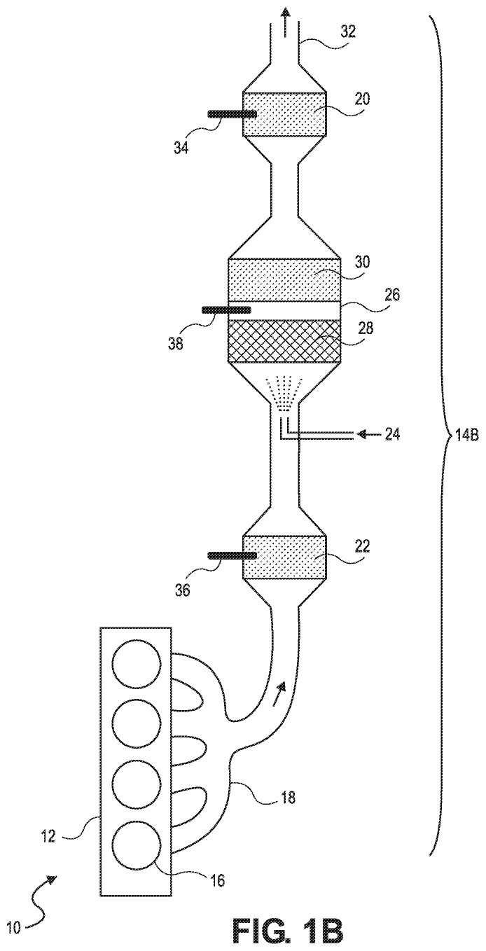

Referring to FIG. 2, a plot 40 is illustrated depicting the relationship of the exhaust gas temperature at the exhaust manifold 18 versus the operating load for a representative boosted, compression-ignition, engine 12 operating at 1250 rpm without cylinder deactivation.

In this example, the curve 42 represents the exhaust gas temperature as a function of engine load expressed in Brake Mean Effective Pressure (BMEP) for the case where all engine cylinders are firing under substantially the same conditions.

The operating range 44 is the temperature range of the exhaust gases in the exhaust manifold 18 that result in effective operation of the aftertreatment system. In this particular example, the operating range is approximately 225° to 425° C.

As previously noted, the exhaust gases will typically cool somewhat at each stage of either aftertreatment system 14A/14B. For example, by the time the exhaust gases reach the reducing catalytic converters 28, 30 in aftertreatment system 14A, the temperature may have dropped approximately 25° C. In other words, the temperature of the exhaust gases is at or near the representative operating range of the reducing catalytic converter 26, which as noted above, may be 200° to 400° C.

It is important to note that the provided temperature ranges at the exhaust manifold 18 and at the last stage of the aftertreatment systems 14A/14B are merely example and should not be construed as limiting in any regard. On the contrary, different engine operating points and engine designs may have different starting, intermediate, and ending temperatures and temperature offsets between the exhaust manifold 18 and the last element of the aftertreatment systems 14A/14B. In fact, in some cases, the exhaust gas temperatures may rise in the exhaust system due to exothermic chemical reactions. As such, the actual temperature values and ranges as provided herein should not be construed as limiting the scope of the present invention.

### Skip Fire Control System

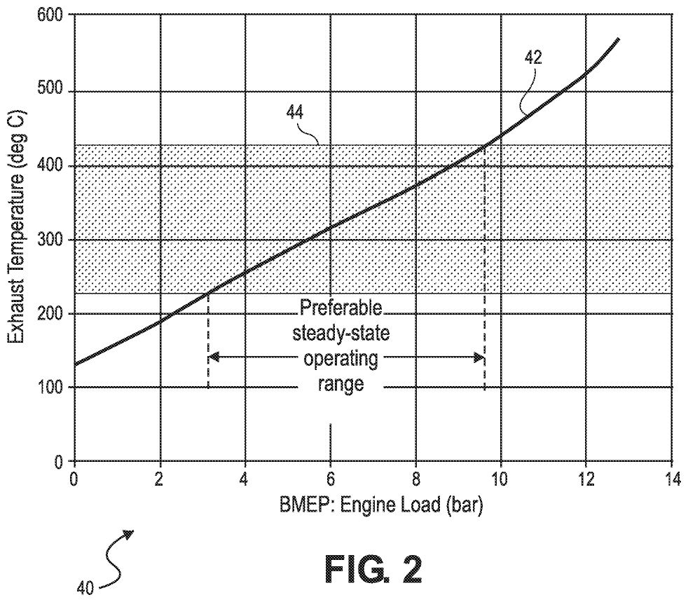

Referring to FIG. 3, a schematic diagram of an engine controller 50 illustrating a number of controls and/or systems for controlling operation of the engine in a skip fire mode are illustrated. These control systems include an Exhaust Gas Recirculation (EGR) system controller 52, a turbocharger controller 54, a fuel control unit 56, and a skip fire controller 58.

The EGR system controller 52 operates to recirculate a portion of the exhaust gas back to the cylinders of the engine. The recirculation tends to dilute the fresh air intake stream into the cylinder with gases inert to combustion. The exhaust gases act as absorbents of combustion generated heat and reduce peak temperatures within the cylinders. As a result, NOₓ emissions are typically reduced. In a compression-ignition Diesel engine for instance, the exhaust gas replaces some of the oxygen in the pre-combustion mixture. Since NOₓ forms primarily when a mixture of nitrogen and oxygen is subjected to high temperature, the lower combustion temperatures and reduction in the amount of oxygen in the working chamber cause a reduction in the amount of generated NOₓ.

The boost controller 54 controls the amount of compressed air that is inducted into the cylinders 16 of the engine 12. Boosting, that is supplying compressed air to engine 12, allows generation of more power compared to a naturally aspirated engine since more air, and proportionally more fuel, can be input into the cylinders 16. The boost controller 54 may operate with either a turbocharger, a supercharger, or a twin-charger.

The key difference between a turbocharger and a supercharger is that a supercharger is mechanically driven by the engine, often through a belt connected to the crankshaft, whereas a turbocharger is powered by a turbine driven by the exhaust gas of the engine. Compared with a mechanically driven supercharger, turbochargers tend to be more efficient, but less responsive. A twin-charger refers to an engine with both a supercharger and a turbocharger.

The fuel control unit 56 is used to determine the amount of fuel required by the cylinders 16 of the engine 12. The amount of injected fuel is based primarily on the torque request since the efficiency of torque generation is not strongly influenced by the air/fuel ratio for lean burn engine. There must however be adequate air flow into the engine to combust the delivered fuel. Most vehicles rely on a mass airflow sensor to determine the amount of air. Given the air flow into the engine and injected fuel mass, the air-fuel ratio, which is one of the inputs into engine controller 50 may be determined. Based in part on this value, the fuel control unit 56 makes a determination of how much fuel to inject into the cylinders 16 of the engine 12. As previously noted, the air-fuel ratio for a Diesel engine may range from approximately 16 to 55 compared to 14.6 for a stoichiometric air-fuel ratio.

The skip fire controller 58 is responsible for determining if the engine 12 should operate in either a full displacement mode or in the skip fire mode. When no firing fraction, other than one, is adequate to meet a high torque demand, then the skip fire controller will operate the engine 12 at full displacement. Otherwise, the engine is typically operated at one of multiple reduced effective displacements, each defined by a different firing density or fraction, in the skip fire mode.

When in the skip fire mode, the skip tire controller 58 is responsible for determining a firing density or firing fraction that meets a current torque request. In other words, the skip fire controller 58 defines a firing fraction that is suitable to (1) meet the current torque request and (2) operate the vehicle at acceptable levels of noise, vibration, and harshness (NVH). Satisfying these two constraints generally have the highest priority in the engine control architecture. Other parameters that may also be optimized are (3) fuel efficiency, (4) exhaust gas temperature, and (5) air/fuel ratio. Point (3) needs no explanation since it is clearly advantageous to minimize fuel consumption. Points (4) and (5) stem from a desire to reduce the burden on aftertreatment elements in the exhaust system and to improve tailpipe emissions. As driving conditions change (i.e., the engine speed and torque demand change), the skip fire controller 58 is responsible for selecting different firing fractions, each indicative of different reduced effective displacements less than the full displacement of the engine 12, that best meets the five objects (1) through (5) articulated above.

The skip fire controller 58 receives at least three inputs, including (a) a current torque request. (b) a signal 60 indicative of the temperature of the exhaust gases in the aftertreatment system 14A/14B, and (c) an air-fuel ratio of one or more active cylinders 16 of the engine 12. In response, the skip fire controller 58 generates a firing density or fraction 62. With these three inputs, the skip tire controller 58 is able to provide ever finer control of the engine 12, selecting an optimum firing density that best meets objectives (1-5) mentioned above.

The turbocharger controller 54 receives the (a) current torque request, (b) signal 60 indicative of temperature of the exhaust gases in the aftertreatment system 14A/14B, (c) air-fuel ratio provided to one or more of the cylinders 16 of the engine 12, and (d) an output of the skip fire controller 58. In response, the boost controller 54 determines the amount of compressed air that is to be inducted into the cylinders 16 of the engine 12.

The EGR system controller 52 similarly receives the (a) current torque request, (h) signal 60 indicative of temperature of the exhaust gases in the aftertreatment system 14A/14B, (c) air-fuel ratio provided to one or more of the cylinders 16 of the engine 12, and (d) an output of the skip tire controller 58. In response, the EGR system controller 52 determines the amount or percentage of exhaust gases that are to be recirculated. Again, by receiving the three inputs (a), (b) and (c), the EGR system is able to make a more precise determination on the amount of exhaust gases to recirculate.

The outputs from the skip fire controller 58, the boost controller 54 and the EGR controller 52 are then all considered to generate an air intake value 68, which is provided to the cylinders 16 of the engine 12. In addition, as noted above, the fuel control unit 56 considers the air intake value 68 in providing an appropriate amount of fuel to the cylinders 16 of the engine 12. The fuel and the air, together, define an air-fuel mixture provided to the cylinders 16, characterized by an air-fuel ratio.

In a non-exclusive embodiment, the skip fire controller 58 is a dynamic skip fire controller. In other words, the skip fire controller 58 makes a decision to fire or not fire a given cylinder of an engine dynamically, meaning on a firing opportunity-by-firing opportunity basis.

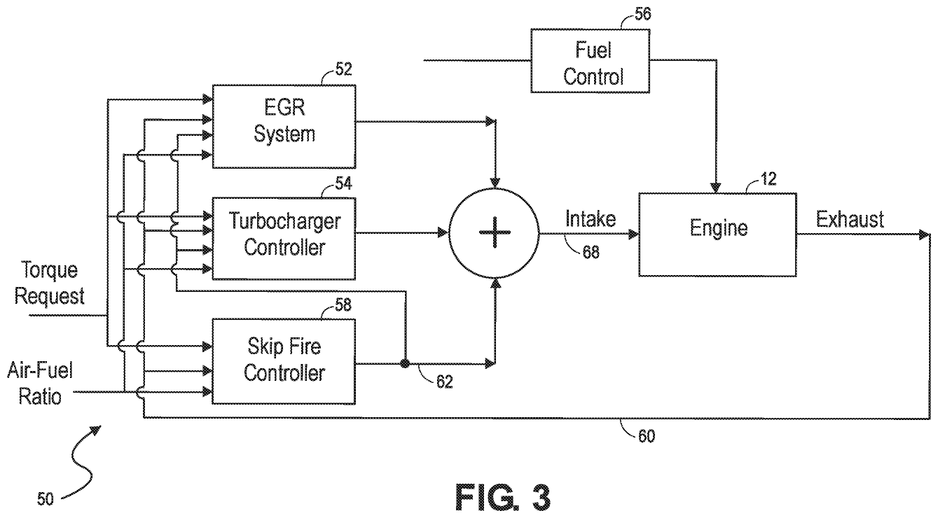

Referring to FIG. 4, a logic diagram of the skip fire controller 58 is illustrated. In this example, the skip fire controller 58 includes a firing fraction calculator 70, a firing timing determination unit 74, a power train parameter adjusting module 76, a firing control unit 78 and an aftertreatment monitor 80.

The firing fraction calculator 70 may receive at least three inputs including (a) a current torque request 72A, (b) a temperature of the exhaust gases as provided by the aftertreatment monitor 80, which receives signal 60 and (c) a target air-fuel ratio 72B. In response, the firing fraction calculator 70 determines a skip fire firing fraction or firing density that best matches the objectives noted above. It should be appreciated that a firing fraction or density may be conveyed or represented in a wide variety of ways. For example, the firing fraction or firing density may take the form of a firing pattern, sequence or any other firing characteristic that involves or inherently conveys the aforementioned percentage or density of firings.

In yet other embodiments, the firing fraction calculator 70 may take into account other information in determining the firing density. Such other information may include, for example, vehicle speed, engine speed, transmission gear ratio, oxygen sensor data, NOₓ sensor data, ambient air temperature, exhaust gas temperature, catalyst temperature, barometric pressure, ambient humidity, engine coolant temperature, etc. In various embodiments, as these parameters change with the passage of time, the firing fraction may be dynamically adjusted in response to the changes.

The aftertreatment monitor 80 represents any suitable module, mechanism and/or sensor(s) that obtain data relating to a temperature of an aftertreatment element. In some embodiments, the skip fire controller 58 and the aftertreatment monitor 80 do not require a direct measurement or sensing of the temperature of an aftertreatment element. Instead, an algorithm using one or more inputs, such as a catalytic converter temperature model, may be used to estimate the aftertreatment element or system temperature. The model may be based on one or more of the above parameters (e.g., oxygen sensor data, NOₓ sensor data, exhaust gas temperature, ambient temperature, barometric pressure, ambient humidity, etc.) that are representative or related to a catalytic converter temperature.

The firing timing determination unit 74 receives input from the firing fraction calculator 70 and/or the power train parameter adjusting module 76 and is arranged to issue a sequence of firing commands (e.g., drive pulse signal) that are provided to the firing control unit 78. The firing timing determination unit 74 may take a wide variety of different forms. For example, in some embodiments, the firing timing determination unit 74 may utilize various types of lookup tables to implement the desired control algorithms. In other embodiments, a sigma delta converter or other mechanisms are used. The sequence of firing commands (sometimes referred to as a drive pulse signal 75) are provided to the firing control unit 78, which orchestrates the actual firings of the cylinders 16 of the engine 12.

The power train parameter adjusting module 76 directs the firing control unit 78 to set selected power train parameters appropriately to ensure that the actual engine output substantially equals the requested engine output at the commanded firing fraction or density. By way of example, the power train parameter adjusting module 76 may be responsible for determining the desired fueling level, number of fuel injection events, fuel injection timing, exhaust gas recirculation (EGR) level, and/or other engine settings that are desirable to help ensure that the actual engine output matches the requested engine output.

The firing control unit 78 receives input from the firing timing determination unit 72 and the power train parameter adjusting module 76. Based on the aforementioned inputs, the firing control unit 78 directs the engine to operate in the firing sequence 75 determined by the firing timing determination unit 74 with the engine parameters determined by the power train parameter adjusting module 76.

By way of example, some suitable firing fraction calculators, firing timing determination units, power train parameter adjusting modules and other associated modules are described in co-assigned U.S. Pat. Nos. 7,954,474; 7,886,715; 7,849,835; 7,577,511; 8,099,224; 8,131,445; 8,131,447; 9,086,020; and 9,120,478: U.S. patent application Ser. Nos. 13/774,134; 13/963,686; 13/953,615; 13/886,107; 13/963,759; 13/963,819; 13/961,701; 13/843,567; 13/794,157; 13/842,234; 13/004,839, 13/654,244 and 13/004,844, each of which is incorporated herein by reference in its entirety for all purposes.

The value of controlling the air-fuel ratio as part of a skip fire control algorithm. With addition of air-fuel ratio and exhaust temperature as inputs to skip fire controller 58, an appropriate firing density can be selected for a desired torque output, air-fuel ratio and exhaust gas temperature. The selected firing density may or may not be optimal for fuel consumption. However, in certain circumstances, achieving low tailpipe emissions to meet regulatory requirements is more important than the absolute highest fuel efficiency.

In order to accurately control the air-fuel ratio in a firing cylinder, the inducted mass air charge (MAC) must be accurately estimated. As disclosed in U.S. Pat. No. 9,945,313 and U.S. patent application Ser. No. 15/628,309, both of which are incorporated by reference herein in their entirety for all purposes, determination of inducted air mass is more complex in skip fire controlled engines than in engines operating at a fixed displacement. Adjustments to the cylinder MAC may be made based on a firing history of the cylinder and on an engine skip-fire sequence preceding firing of the cylinder.

As described above, controlling the air-fuel ratio in a firing cylinder can be an important element in skip fire control. Additionally, control of fuel injection timing and fuel injection pattern is also important. Even though the air-fuel ratio is the same in different working cycles, the generated torque and combustion byproducts may differ depending on the timing and pattern of the fuel injection. Fuel injection timing refers to when fuel is injected in a cylinder relative to position of a piston in the cylinder, typically denoted by crankshaft angle. Fuel injection pattern refers to the number and duration of discrete fuel injection events that may occur during a working cycle. For example, rather than all fuel being injected in a single event, the fuel injection may be discontinuous with multiple injection events in a working cycle that in total deliver the desired fuel mass.

A cylinder that was skipped on one or more prior working cycles will have cooler cylinder walls than if it had been fired. The greatest impact on cylinder wall temperature is from the immediately prior working cycle, but the cylinder firing history for approximately the past five firing opportunities will influence cylinder wall temperature. Additionally, the composition of residual gases in the cylinder may be different if the preceding firing opportunity was a skip rather than a fire. These changes in the initial conditions at the onset of combustion can impact combustion dynamics. To adjust for the different initial combustion conditions, the timing and pattern of fuel injection may be optimized based on the firing history of the cylinder. The desired air-fuel ratio may also be optimized. Adjusting fuel injection timing, fuel injection pattern, and air-fuel ratio may reduce undesirable combustion products and increase fuel efficiency in the fired cylinder.

In addition, during transition from one steady state to another steady state condition (i.e., a transition from one firing density to another), the use of the three inputs as described herein provides flexibility and control to optimize air-fuel ratio and/or exhaust gas temperature in such a way as to minimize spikes in engine-out emissions during firing density transitions, which was previously not possible.

### Controlling Firing Density to Modulate Exhaust Temperature

The skip fire controller 58 can be used to modulate the temperature of the exhaust gas in several ways. First, by either skipping or firing cylinders 16, the temperature can be controlled. Second, with skipped cylinders, either pumping air through the cylinder or deactivating the cylinder by closing one or both of the intake or exhaust valve(s) so that no air is pumped through the cylinder.

Different firing densities change the workload of the individual cylinders 16 of the engine 12. If many or all are fired, each cylinder 16 performs less work. If fewer are fired, each cylinder 16 performs more work. In general, the more work a given cylinder 16 performs, the higher the temperature of the exhaust gas from that cylinder.

One specialized firing density is utilized for a process called Deceleration Cylinder Cut Off (DCCO). DCCO occurs in certain driving situations when the driver or other autonomous or semi-autonomous driving controller makes no torque demand (e.g., the accelerator pedal is not pressed), such as when a vehicle is coasting downhill or to a stop. In DCCO, the cylinders of the engine are typically not fueled and the intake and/or exhaust valves are closed (i.e., deactivated). As a result, fuel is saved and pumping losses are reduced. The DCCO process will be discussed in more detail below.

The skipping of a cylinder 16 can be implemented in one of two ways. First, either the intake or exhaust valves (or both) can be closed during a skipped firing opportunity. As a result, no air is pumped through the cylinder. Second, both the intake and the exhaust valves can be opened, but no fuel is provided to the cylinder during a skipped firing opportunity. As a result, air is pumped through the chamber, but there is no combustion. When air is pumped into the exhaust system, the effect is to reduce the temperature of the exhaust gases. Thus, by either allowing skipped cylinders to either pump or not pump air, the temperature of the exhaust gases can be further controlled or modulated.

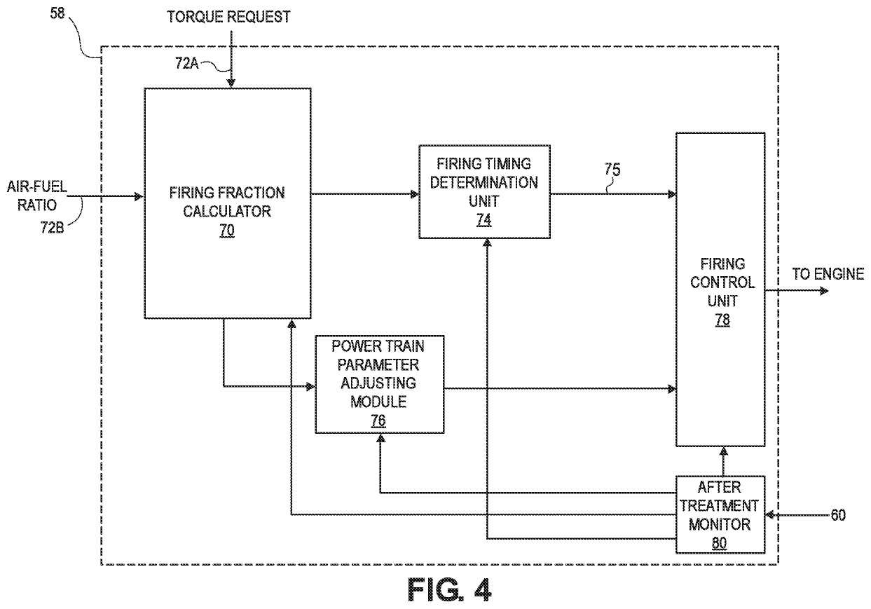

FIG. 5 illustrates a representative engine 12 including four cylinders 16. The engine 12 is arranged to receive fuel from the fuel control unit 56 (see FIG. 3) and intake gas flow from a combination of an EGR system 88 controlled by the EGR system controller 52 (see FIG. 3) and a turbocharger system 90 controlled by the boost controller 54 (see FIG. 3). The EGR system 88 includes an EGR flow valve that controls flow of exhaust gases back into the intake gas flow of the engine 12. The turbocharger system 90 includes an exhaust turbine 92, a shaft 94, and a compressor wheel 96. The compressor wheel 96 is part of a compressor that serves to increase pressure in an intake manifold above atmospheric pressure. An optional cooler 98 may also be provided to cool the intake air allowing a higher MAC. Air from the intake manifold is inducted into a cylinder thru one or more intake valve(s) on each cylinder.

FIG. 5 depicts an example of a firing density (FD) transition from 1.0 to 0.0. Prior to the transition, all four cylinders are fired as illustrated on the left side of the figure. After the transition, none of the four cylinders are fired, all the cylinders are skipped, as graphically illustrated by the “X” through all of the four cylinders 16 on the right side of the figure.

In some implementations, the management of the transition can be made more gradual, by firing at one or more intermediate firing densities between the higher firing density and the lower firing density. Equivalently, the transition between the initial and final target firing density may be viewed as occurring over multiple engine cycles. For instance, if the initial firing density is 1.0 and the target firing density is 0.0, then one or more intermediate firing densities of (0.8, 0.6, 0.4, and 0.2) may be used to smooth the transition. By using one or more intermediate firing densities, the air-fuel ratio in the fired cylinders 16 remains relatively stable, and as a result, NVH, drivability, and smoothness issues regarding this firing density transition are minimized. The transition from the initial to the target firing faction may occur, for example, over 3 to 15 engine cycles depending on the exact nature of the transition.

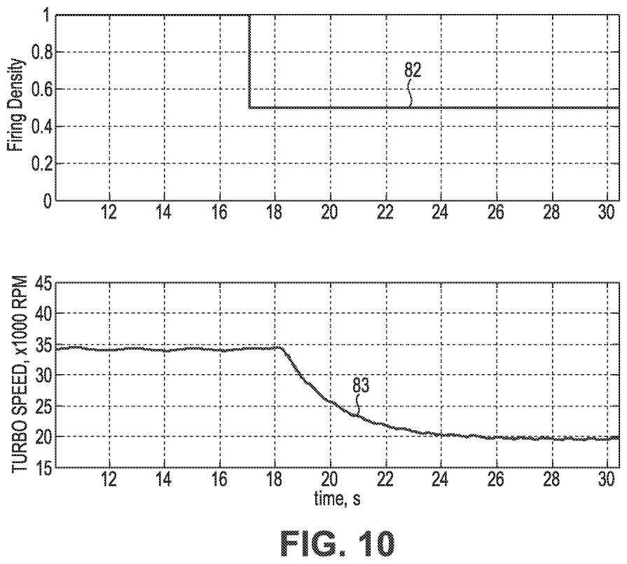

Since there is very little air flow to the turbocharger 90 at FD=0.0, shaft 94 rotation slows also slowing the rotation of the compressor wheel 96. However, as mentioned above, the turbocharger system has inertia which limits how fast it can accelerate and decelerate and, as such, provides some time between when the firing density changes to 0.0 and the time that the shaft comes to a stop. This process and its use in DCCO will be discussed in more detail below with respect to FIGS. 10-15.

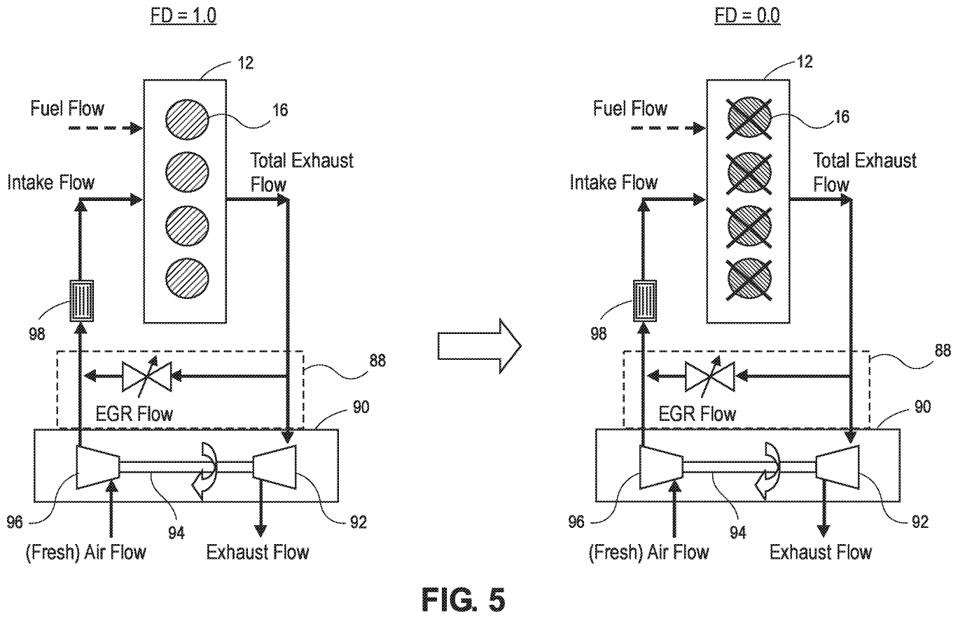

Referring to FIG. 6 a schematic block diagram for system 100 having a valve deactivation controller 102 is shown. In various embodiments, the valve activation controller 102 may be included in or separate from the skip fire controller 58.

The valve deactivation controller 102 receives an input 104 indicative of the actual and/or an estimate of the exhaust temperature in the aftertreatment system 14A/14B, an input 106 indicative of the amount of compressed air that is forced into the cylinders 16 by the turbocharger 90 (or some other type of boost system), the current torque request 108, and an input 110 indicative of the firing density as determined by the skip fire controller 58. In response, the valve deactivation controller 102 makes a decision for the skipped cylinders 16 to either:
(1) Prevent pumping by closing either the intake and/or exhaust valves of the skipped cylinder 16; or
(2) Allowing air to be pumped through the deactivated cylinder 16 by opening both the intake and exhaust valves. Since no fuel is provided to the cylinder 16, no combustion occurs, and intake air is pumped into the aftertreatment system 14A/14B.

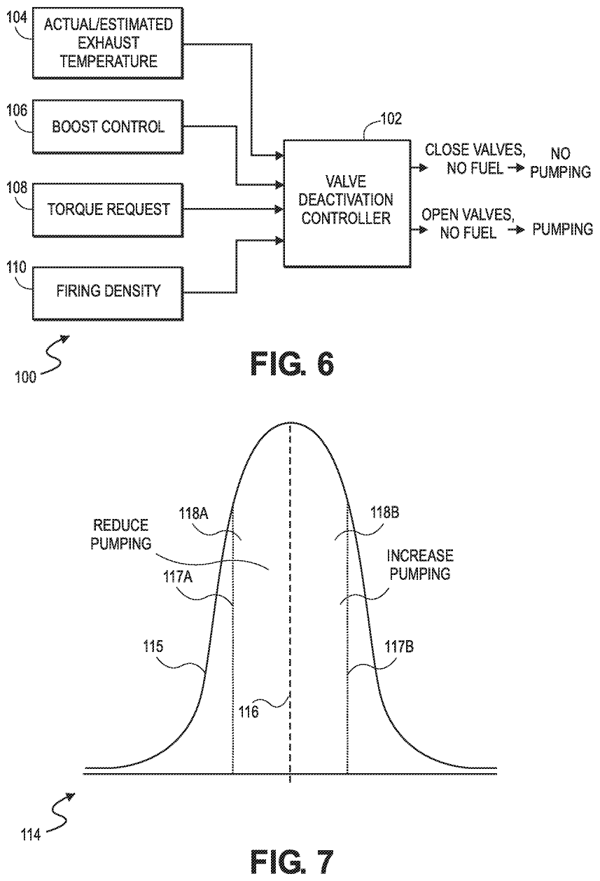

FIG. 7 is a diagram 114 illustrating how the valve deactivation controller 102 may be used to modulate exhaust temperatures. Curve 115 represents efficiency of the reducing catalyst as a function of the reducing catalyst temperature. As noted, a representative operating range for the reducing catalyst may be in the range of 200° to 400° C., which is defined by the region between dotted lines 117A and 117B. The line 116 represents a threshold temperature value below the maximum operating range of 400° C. The precise temperature value of the threshold 116 may vary, but in general, it represents a preferred or target operating temperature of the reducing catalytic converter.

The threshold value may be offset toward the upper bound of the operating temperature range as shown in FIG. 7, since pumping air through the engine will rapidly reduce the catalyst temperature, whereas not pumping air has a more gradual impact on catalyst temperature. When the actual exhaust temperature is in the region 118A (i.e., below the threshold 116), then the valve deactivation controller operates to prevent pumping of the skipped cylinders. As a result, the temperature in the aftertreatment system will be essentially maintained or prevented from decreasing. If the actual exhaust temperature is in the region 118B (i.e., above the threshold 116), then the valve deactivation controller operates to allow pumping of the skipped cylinders. As a result, the temperature in the aftertreatment system will tend to decrease.

The ability to control or modulate the temperature of the exhaust gas can, therefore, be implemented by (1) firing or skipping cylinders and/or (2) by either allowing or preventing pumping on skipped cylinders. In alternative embodiments, just the cylinder firing/skipping can be used, or alternatively, both techniques can be cooperatively used.

### Turbocharger Control

Most turbochargers rely on a contour efficiency map that specifies a high efficiency region defined by (a) a particular pressure range and (b) an air volume range. The contour efficiency map also defines a surge line that should not be exceeded. If the pressure exceeds the surge line, the chance of mechanical damage to the turbocharger and/or the engine increases significantly.

Cylinder deactivation tends to increase the MAC and pressure in the firing cylinders. With one or more deactivated cylinders, the intake air is shared among fewer active cylinders, causing an increase of pressure than if all the cylinders are active. As a result, cylinder deactivation may increase the chance that the surge line of the turbocharger is exceeded. A priority scheme that balances priority between the torque requests, exhaust temperature, and preventing a turbocharger from exceeding its surge line is therefore desirable.

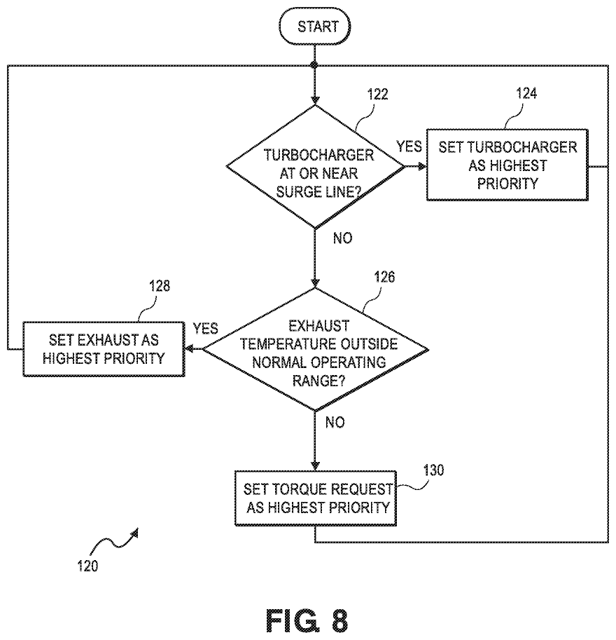

Referring to FIG. 8, a logic flow diagram 120 illustrating a prioritization scheme implemented by the skip fire controller and/or the valve deactivation controller is shown. The intent of the prioritization scheme is to continually monitor the exhaust temperature, the turbocharger operating conditions, and the current torque request and to set priorities on which should take precedent based on real-time operating conditions. Since the likelihood of turbocharger and/or engine damage increases dramatically if the surge line is exceeded, the turbocharger is preferably set as the highest priority. Second in priority is the exhaust gas temperature, which can damage the exhaust system if it exceeds an operational limit for an extended period of time or lead to unacceptable emissions if it is outside of its normal operating region. Third in priority is the desire to meet the requested engine torque.

The logic flow diagram starts and proceeds to decision step 122. In decision step 122 the turbocharger is continually monitored. If the turbocharger compressor is operating at or near the surge line, then the turbocharger is given the highest priority and the flow diagram proceeds to step 124.

In step 124, the skip fire controller and/or the valve deactivation controller operate so as to move the turbocharger operating point away from the surge line, so there is sufficient operating margin to avoid a surge. Such action may include activating more cylinders, reducing the air intake, reducing the pressure generated by the turbocharger, reducing the EGR flow, reducing engine torque, etc.

On the other hand, if the turbocharger is operating well away from the surge line, then the flow diagram proceeds to decision step 126. In decision step 126 it is determined if exhaust gases are operating outside of a predefined normal range (e.g., 200° to 400° C.).

If yes, then the exhaust temperature is set as the highest priority (step 128). The skip fire controller and/or the valve deactivation controller operate to adjust the exhaust temperature to within its normal range by activating or deactivating cylinders and/or reducing the engine torque.

If the exhaust gas temperature is within its normal operating range, then the current torque request is set as the priority (step 130). As a result, the firing density defined by the skip fire controller is defined predominately to meet the current torque request. The air-fuel ratio can be controlled so that the engine generally operates in a region where engine generated pollutants are minimized.

During operation, the above decisions are continually made. As a result, the priority of the skip fire controller and/or the valve deactivation controller are continually updated to meet current operating conditions. As issues with the turbocharger and/or aftertreatment system occur, they are prioritized and corrected. When no issues are present, then meeting the current torque demand is the priority.

### Managing Firing Density Transitions

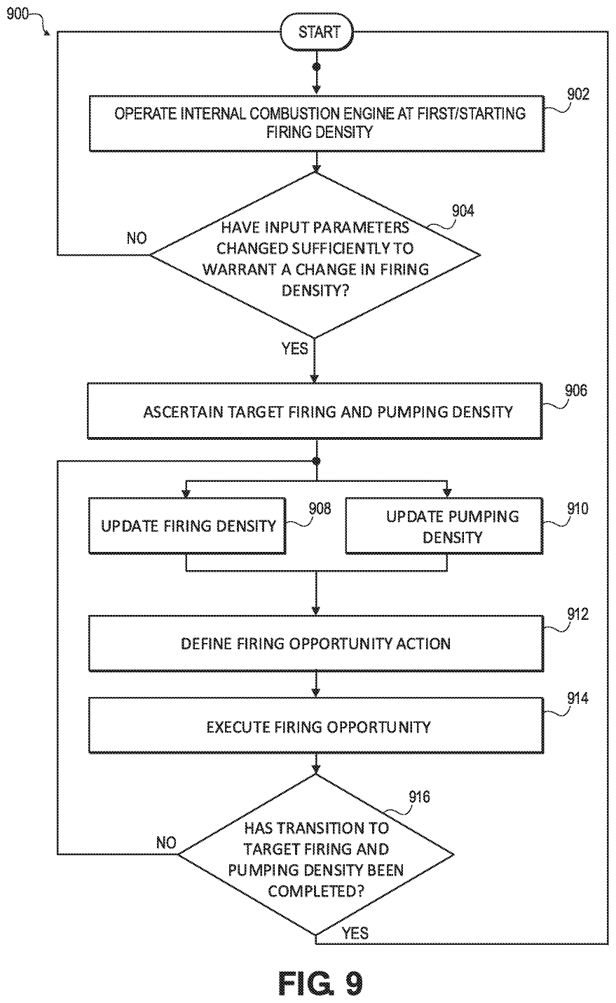

Referring to FIG. 9, a flow chart 900 illustrating steps for operating an internal combustion engine with separately defined firing and pumping densities during transitions is illustrated.

In the initial step 902, the skip fire controller operates the internal combustion engine at the current (i.e., a starting or first) firing density as needed to meet the current torque demand.

In a decision 904, the skip fire controller determines if input parameters have sufficiently changed to warrant a change in the firing density. As depicted in FIG. 3, the input parameters include a torque request, an air-fuel ratio, and a signal from an aftertreatment element monitor. Additional input parameters not shown in FIG. 3 may include vehicle speed, engine speed, transmission gear ratio, oxygen sensor data, NOₓ sensor data, ambient air temperature, exhaust gas temperature, barometric pressure, ambient humidity, and engine coolant temperature. If the input parameters have not sufficiently changed, the skip fire controller continues to operate the engine at the current firing density as provided in step 902.

If the input parameters have sufficiently changed, then in step 906, the skip fire controller determines a new target firing and pumping density. Generally, when the firing density transition is completed, the pumping density will equal the firing density.

In steps 908 and 910, the skip fire controller updates the firing density (step 908) and pumping density (step 910) for the next firing opportunity. The firing density and pumping density may follow a pre-determined trajectory through the firing density transition. That is for each firing opportunity, a value for the firing density and pumping density may be determined from a look-up table, an algorithm, or by some other means.

In step 912 skip fire controller defines the action of the next firing opportunity. That is, the skip fire controller determines whether the next firing opportunity will cause a cylinder associated with the firing opportunity to either (a) fire, (b) pump without firing, or (c) be deactivated.

In step 914, the firing opportunity is executed. The cylinder associated with the firing opportunity is either (a) fired, (b) pumped but not fired or (c) deactivated, depending on the results from step 912. Thus, for a typical 4-stroke engine, one of the following is performed:
(1) If fired, (i) air from the intake manifold is inducted into the cylinder during the intake stroke, (ii) fuel is injected into the cylinder, (iii) the air-fuel mixture is compressed during the compression stroke, (iv) combustion occurs during the combustion stroke, and (v) combustion and other gases are exhausted out of the cylinder during the exhaust stroke.
(2) If pumped but not fired, the same sequence (i) through (v) are performed, but step (ii) is omitted. With no fuel, no combustion occurs. As a result, the inducted air is pumped through the cylinder and into the exhaust manifold during the exhaust stroke; and
(3) If deactivated, no fuel is injected into the cylinder and either the intake valve(s) and/or exhaust valve(s) are closed to prevent pumping of air from the intake manifold, through the engine, into the exhaust manifold.

In step 916, it is determined if the transition to the target firing and pumping density is complete or not. If not, then the process flow moves back to steps 908 and 810 where the firing density and pumping density are updated for the next firing opportunity.

Steps 912, 914, and 916 are then repeated for the next firing opportunity. On the other hand, if the transition to the target firing density and pumping density is complete, then control is returned to step 902. The engine operates at the target firing density until another change in the torque demand or other input condition sufficient to warrant a change in firing density is determined. Possible other input conditions that may warrant a change in firing density include, but are not limited to, changes in aftertreatment element temperature, turbocharger settings, EGR settings, and the air-fuel ratio.

FIGS. 10-15 illustrate ways in which DCCO timing can be adjusted to benefit turbocharger performance according to various embodiments of the present disclosure.

### Deceleration Cylinder Cut Off (DCCO)

Dynamic skip fire technology provides the ability to cut off all cylinders and offers benefits for doing so, at some times during engine operation. For example, it saves fuel. It also does not pump any air through any of the chambers, so there is also reduced pumping.

Because the cylinders are not pumping any cold air through the engine, this process does not cool down the components of the aftertreatment system. This can be helpful because some components of the aftertreatment system to need to be above a certain threshold temperature to provide the best conversion efficiency of byproducts created during the combustion process, for example, limiting NOx emissions or other emissions.

So, typically in practice, the vehicle is being driven and the firing fraction will depend on the demand based on the driver's input (depression of the gas pedal) and depending on the specific characteristics of the engine (torque, engine speed, gearing, etc.) then the engine controller determines how many cylinders are to be fired at that particular time. Typically, when the driver is not depressing the pedal, DCCO will be utilized. In DCCO, not only is no fuel being injected into the cylinders, intake valves or all valves to the cylinders are closed so there is no air going through the cylinders either.

If the engine has a turbocharger, the turbocharger requires a certain amount of air flow to keep the turbocharger spinning. But, when DCCO is implemented, it completely shuts off all cylinders, there is very little to no air flow, and if DCCO is active for a period of time, the turbocharger will eventually stop spinning.

Currently, this means that DCCO typically is not run on engines having turbochargers as starting the spinning of the turbocharger creates a response lag that is detrimental to engine performance and can be annoying to the driver, among other issues discussed below. However, the present disclosure teaches several processes where DCCO can still be utilized in a beneficial manner on turbocharged engines.

For example, there are a few seconds between beginning a no flow process (e.g., via DCCO) and where the turbocharger reaches a rotation speed at which the speed is too low for beneficial turbocharger performance. So, for example, if the turbocharger is operating and 40,000 rpm (e.g., with a high end output of 100,000 rpm) and a low flow process is implemented, the turbocharger has a rotational inertia and the rpms will decrease over time (e.g., several seconds) and not stop the turbocharger immediately. In this time, the no flow process can be utilized to still provide the above benefits.

This could occur, for example, as the turbocharger decreases to 10,000 rpm. A sample timeframe could be 6-7 seconds. Once the turbocharger reaches the low threshold (as opposed to the upper threshold discussed above for avoiding damage), the engine controller ends the use of DCCO and opens cylinders to maintain the turbocharger at the threshold or to begin to spin the turbocharger back up.

One other benefit of the processes of the present disclosure is that there is less wear on the bearings of the turbocharger. When the turbocharger spins up from a stop, there is more stress on the bearings than if the turbocharger is already spinning.

Turbochargers are currently not designed with DCCO in mind. They are designed to only be in a stopped state when the vehicle is off and when operational, the turbocharger should be spinning. Consequently, the increased stress on the bearings creates more wear on the bearings requiring more maintenance and earlier replacement.

One example, provides that the turbocharger rotational speed is at 40,000 rpm, the engine is in all cylinder firing mode, and driver torque demand drops, the engine controller initiates DCCO, and the induction ratio (amount of air entering the cylinders) goes to zero. Once in DCCO, the turbocharger rotational speed begins to drop because there is no air flow, then once it hits a 10,000 rpm threshold, the engine controller initiates a steady state firing fraction (e.g., ⅙) which is sufficient to keep the turbocharger rotational speed above the threshold. As the firing fraction indicates, this can include making one or two cylinders operational as driver torque demand is still zero.

In some embodiments, the engine controller can switch from all cylinder firing mode directly to the firing mode that maintains the turbocharger above the threshold. However, it may be more beneficial to use the time period, between all firing modes and when the threshold is reached, to be in DCCO.

As stated above, DCCO occurs in certain driving situations when the driver or other autonomous or semi-autonomous driving controller makes no torque demand (e.g., the accelerator pedal is not pressed). In DCCO, the cylinders of the engine are typically not fueled and the intake and/or exhaust valves are closed (i.e., deactivated).

Since the cylinders in DCCO operation are typically not fired over numerous consecutive firing opportunities, the air and/or re-circulated exhaust gases in the intake manifold may increase in temperature. The temperature in the intake manifold can be either measured or modeled. Either way, pumping through the engine can be used upon the ceasing of DCCO to reduce the temperature of the gases in the intake manifold on an “as needed basis”. The measured or modeled data can be used to determine the amount and timing of the pumping.

A real-world driving scenario where a DCCO exit strategy may be beneficial is mountainous driving. When a vehicle drives up a long mountain climb, the torque demand on the engine will typically be very high for a long period of time, creating large amounts of waste heat and resulting in high engine operating temperatures. When the vehicle crests the mountain peak and begins driving down the mountain, DCCO mode may be used if no torque is demanded, as would typically be the case when coasting downhill. The DCCO operation may result in trapped gases in the intake manifold becoming excessively hot as heat from the engine is absorbed due to the lack of pumping through the engine. Thus, when a torque demand is made, such as with the start of another mountain climb, the engine may not be able to deliver the needed torque.

A possible solution to the above-described problem is to use the intake manifold gas temperature, or an estimate (e.g., based on modeled data) thereof, as a criterion if DCCO should be used or continue to be used. In the case of high intake manifold temperatures, DCCO is exited, or entry into DCCO is prohibited, and instead some of the cylinders pump air. That is, while the firing density stays at zero, the pumping density is greater than zero.

As a result, cooler fresh air will flow into the intake manifold, preventing heat build-up that can later limit torque production. Because pumping of cooler air corresponds to times when the engine and aftertreatment system are already hot, the induction of cooler air should not significantly impact the efficiency of the aftertreatment system. When the intake manifold gas temperature is relatively low, then DCCO can be used when appropriate.

Also, it is desirable to maintain a pressure differential across the turbocharger to avoid an increase in oil consumption due to leakage from the compressor/turbine bearings. As a result, the duration of a DCCO event may be limited.

Additionally, the engine may be operated by interspersing deactivated firing opportunities with fired firing opportunities and firing opportunities that result in pumping air through the engine. This combination of actions associated with different firing opportunities may result in reduced fuel consumption, since fewer cylinders are fired, while maintaining an adequate turbocharger rotational speed to deliver torque when it is again requested.

Another constraint on DCCO use in a turbocharged engine is maintaining a minimum turbocharger rotational speed. If the turbocharger rotational speed becomes too low or rotation stops, there will be a lag in torque delivery when torque is again requested.

Deceleration cylinder cut off (DCCO) is very useful both for saving fuel and for maintaining high aftertreatment temperatures at no-load/deceleration opportunities. Some turbochargers have minimum speed requirements that require some amount of flow to maintain. Using steady state mapping data to define a minimum firing fraction that satisfies the turbocharger rotational speed requirement in these conditions is one solution. But in transient operation, specifically while going from a high firing fraction to low firing fraction, the turbocharger rotational speed often takes several seconds to decay to the new steady state level.

This can be accomplished by monitoring the turbocharger rotational speed in real time and using that as data to choose what induction ratio/firing fraction to use during the deceleration opportunity. This minimizes the amount of cold air being pumped to the catalyst.

It is possible to achieve DCCO operation for several seconds at a time in transient cycles while the steady state condition requires a non-zero induction ratio. Depending on the initial condition (e.g., factors include turbocharger rotational speed, engine load, exhaust flow rate), the turbocharger rotational speed takes several seconds to drop below the threshold after the engine goes into DCCO mode.

This solves the problem of having to completely disable DCCO to keep the turbocharger performance high. More precisely, this solves the problem of having to maintain a minimum turbocharger rotational speed while also minimizing the amount of cooling power being pumped through the aftertreatment system. If the base system involves having to inject fuel in the pumping cylinder in order to maintain temperature, this solution also saves fuel.

### Turbocharger Rotational Speed Management

FIG. 10 shows an example of transient behavior of a turbocharger during a transition from FF=1 to FF=0.5 in an idle condition (data from 6 cylinder engine). As can be seen from this example, the firing fraction change 82, from 1.0 to 0.5 is immediate, but it takes roughly 8 seconds for the turbocharger rotational speed 83 to reach steady state after the transition completes. Some of this time period can be used by embodiments of the present disclosure for DCCO.

It should be noted that, for example, in a non-idle condition where there is more exhaust flow, the initial turbocharger rotational speed is usually higher than in this example and will take longer to drop down to the required threshold. Also, when the firing fraction drops to 0.0, and there is no exhaust flow, the turbocharger rotational speed can be expected to drop more quickly than in this example.

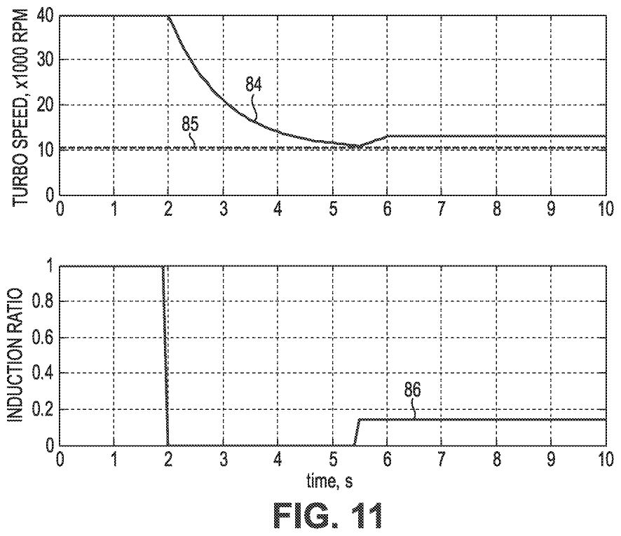

As discussed herein, one way to utilize the opportunity presented by the slow decay in the turbocharger rotational speed is to enable DCCO when the torque demand allows it until the turbocharger rotational speed reaches a preset threshold. Once this threshold is reached, the firing fraction is then changed to a value that can keep the turbocharger rotational speed above this threshold. This is shown in FIG. 11, wherein DCCO is allowed until a lower threshold 85 of the turbocharger rotational speed 84 is reached. This final firing fraction can be fueled or unfueled depending on thermal or emissions requirements.

Also illustrated in the lower graph is the corresponding induction ratio changes that occur during the process shown in the upper graph. Here, the induction ratio 86 is at 1.0 until it switches to 0.0, at which point the turbocharger rotational speed begins to decrease. The turbocharger rotational speed is monitored (e.g., via a rotation sensor) or modeled and this data is used to determine when the turbocharger rotational speed reaches the threshold 85. At this point, the induction ratio 86 is increased (e.g., via the engine controller) to a value that will allow the turbocharger rotational speed 84 to stay above the threshold 85 (at around 5.5 s on the example graphs).

In some embodiments, such as for long durations of deceleration, it may be useful to pulse the exhaust flow using DCCO and a non-zero firing fraction back and forth. This may be used, for example, if the lower firing fraction provides undesirable NVH or the lower firing fraction is otherwise not able to be actuated on a specific engine/hardware configuration.

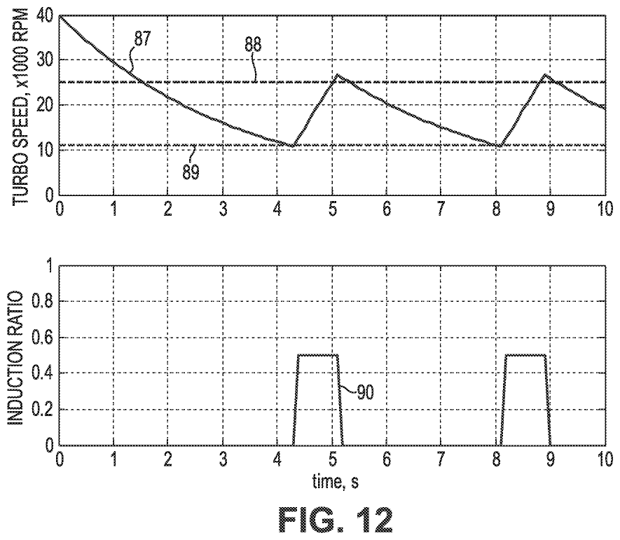

In such implementations, a higher fraction may be capable of elevating the turbocharger rotational speed significantly, allowing another period of DCCO until the turbocharger needs to be spooled up again. This cycle can be repeated as many times as desired until the torque demand takes the engine operation out of deceleration mode. Such an embodiment is described in FIG. 12. The non-zero firing fraction during this cycling may be fueled or unfueled depending on thermal/emissions requirements.

In the embodiment of FIG. 12, instead of a single DCCO period during the decrease in rotational speed from all cylinder firing to the threshold, the engine controller can pulse the engine between DCCO and non-DCCO modes. In such an embodiment, the engine switches into DCCO mode (induction ratio 90 switches from 1.0 to 0.0), the turbocharger rotational speed 87 begins to drop, and drops to a first (lower) threshold 89. In this example, the engine controller selects a higher induction ratio (e.g., firing fraction of 0.5), which will increase the turbocharger rotational speed rather than just maintain it above the threshold. When the turbocharger speed increases and crosses a second (higher) threshold 88, the engine controller can re-enter DCCO mode again until the lower threshold 89 is crossed again and the cycle repeats. As illustrated, the engine controller can determine a target rotational speed 88 and select a suitable firing fraction to achieve that target speed, in some implementations.

In this way, there are other opportunities to utilize DCCO as the turbocharger spins down again toward the threshold (at approximately 5 s and 9 s in the example shown in FIG. 12). This can be done multiple times while there is no torque demand from the driver. For example, the vehicle can be in DCCO for four seconds, one or more cylinders can be pulsed for one second, and then the vehicle can be returned to DCCO for another three seconds, as shown in the example.

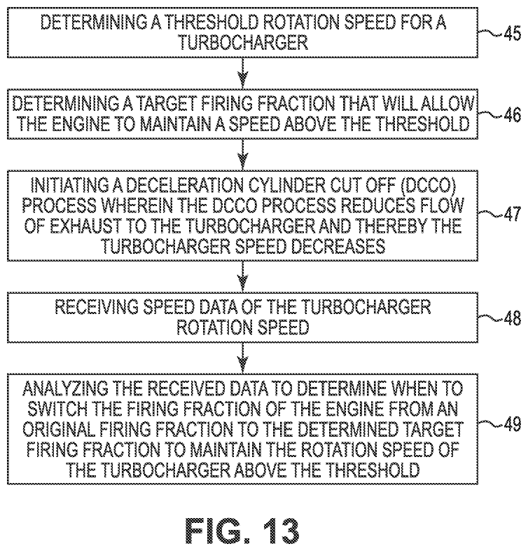

FIG. 13 illustrates an example method embodiment according to the present disclosure. The illustrated method includes determining a threshold rotational speed for a turbocharger, at 45. The target firing fraction that will allow the engine to maintain a speed above the threshold is determined, at 46. At 47, the method includes initiating a deceleration cylinder cut off (DCCO) process wherein the DCCO process reduces flow of exhaust to the turbocharger and thereby the turbocharger speed decreases. The method also includes receiving speed data of the turbocharger rotation speed, at 48. The received data is analyzed to determine when to switch the firing fraction of the engine from an original firing fraction to the determined target firing fraction to maintain the rotational speed of the turbocharger above the threshold, at 49. In this manner, the engine system can benefit from DCCO while also using a turbocharger.

### Variable Geometry Turbocharger (VGT) Control

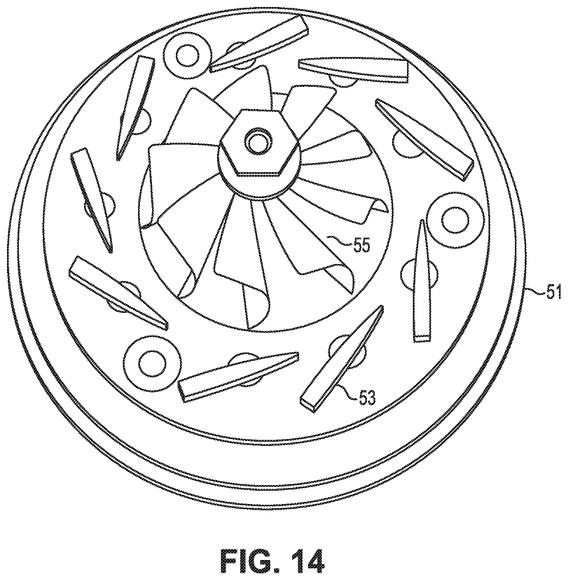

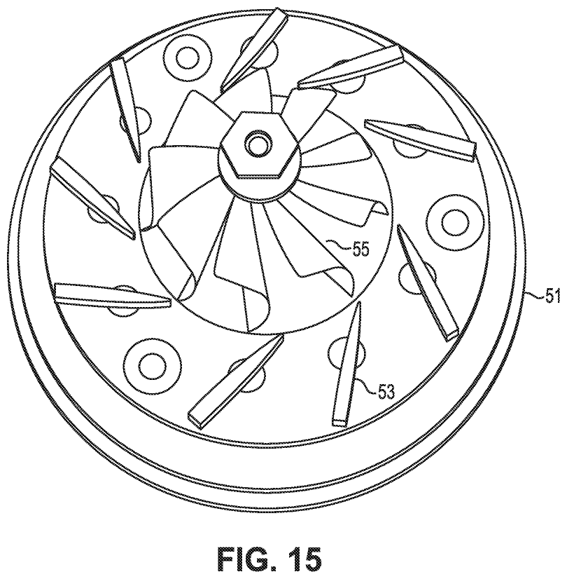

FIGS. 14 and 15 illustrate a variable geometry turbocharger (VGT) with vanes in a more closed state in FIG. 14 and a more open state in FIG. 15. In some implementations, VGT's can be utilized to help with DCCO and turbocharger rotational speed management.

If the vehicle is equipped with a variable geometry turbocharger (VGT) the above described methods can be further optimized by choosing the correct VGT positions during different phases of the process. While a particular variable geometry position might be suitable for elevating the turbocharger rotational speed as quickly as possible with the minimal exhaust flow, another variable geometry position might be more suitable to minimize the decay of the turbocharger rotational speed during DCCO, thus elongating the time in DCCO.

FIG. 14 shows an example VGT having a housing 51, a number of adjustable vanes 53, and a turbine 55 that is driven by air or exhaust gas depending on the mode the engine is operating in. As can be discerned from the comparison between FIGS. 14 and 15, the vanes 53 of FIG. 14 are more closed, making entry of air or gas into the turbine 55 more difficult and more open in FIG. 15, making entry easier.

Variable Geometry Turbocharger (VGT) changes the angle of the vanes in the turbocharger. With vanes on the outside and the turbine on the inside, air flows in from the sides and out through the middle. When the vanes are more restricting, this results in a higher pressure differential making it harder for the gases to push through the turbocharger, but this results in higher turbocharger rotational speed, more back pressure, and more compression of the gases on the intake side of the turbocharger. When the vanes are more open, the gases move through the turbocharger more quickly, leading to lower turbocharger rotational speed, less back pressure, and less compression on the intake side.

Accordingly, a VGT can be used in conjunction with DCCO to modulate the speed of the turbocharger during DCCO periods. In such embodiments, the engine/turbocharger controller can adjust the vanes as appropriate to prolong the spin down of the turbocharger to the threshold. In some cases that may mean opening the vanes and in other cases that may mean closing the vanes. Additionally, when exiting DCCO, it may be beneficial to adjust the vanes to most efficiently or most quickly spin the turbocharger up from the threshold or to an optimal operating rotational speed.

This could, for example, be accomplished by testing and calibrating one or more suitable vane angles, to spin down the turbocharger as slowly as possible during DCCO, thereby extending the period that the engine can be in DCCO.

The systems and techniques disclosed herein allow fuel savings, performance, and thermal advantages to the engine and/or aftertreatment system by allowing more DCCO and its use with turbochargers. Different engine types can have different levels of allowable DCCO. This disclosure allows for multiple different approaches to be utilized in different situations and with different types of engines.

The invention has been described primarily in the context of controlling the firing of 4-stroke, compression ignition or spark ignition, piston engines suitable for use in motor vehicles. However, it should be appreciated that the described skip fire approaches and DCCO/turbocharger management system and techniques are very well suited for use in a wide variety of internal combustion engines, including gasoline and/or spark-ignition (SI) type engines. In addition, any of the engines described herein may be used for virtually any type of vehicle including cars, trucks, locomotives, ships, boats, construction equipment, aircraft, motorcycles, scooters, etc.; and any other application that involves the firing of cylinders and utilizes an internal combustion engine.

Although only a few embodiments have been described in detail, it should be appreciated that the present application may be implemented in many other forms without departing from the spirit or scope of the disclosure provided herein. For example, as described above two sigma-delta converters are used in the determination of an action associated with a firing opportunity in a firing density transition. This is not a requirement. Therefore, the present embodiments should be considered illustrative and not restrictive and is not to be limited to the details given herein but may be modified within the scope and equivalents of the appended claims.

What is claimed is:

1. An engine controller for controlling an internal combustion engine in a vehicle, the controller configured to:
determine a threshold rotational speed for a turbocharger;
determine a target firing fraction that will allow the engine to maintain a turbocharger rotational turbocharger speed above the threshold;
initiate a deceleration cylinder cut off (DCCO) process wherein the DCCO process decreases the turbocharger rotational speed toward the threshold;
receive speed data of the turbocharger rotational speed; and
analyze the received data to determine when to switch a firing fraction of the engine from an original firing fraction to the determined target firing fraction to maintain the rotational speed of the turbocharger above the threshold.

2. The engine controller of claim 1, wherein the engine controller closes valves on one or more cylinders of the engine to operate the engine at the target firing fraction.

3. The engine controller of claim 2, wherein after the engine begins to operate at the target firing fraction, a rotational speed sensor measures the rotational speed of the turbocharger.

4. The engine controller of claim 3, wherein if the measured rotational speed is below the threshold, a higher firing fraction is selected.

5. The engine controller of claim 3, wherein if the measured rotational speed is above the threshold, the target firing fraction is maintained.

6. The engine controller of claim 1, wherein the controller analyzes the received data to determine when to switch the firing fraction of the engine from an original firing fraction to the determined target firing fraction to increase the rotational speed of the turbocharger above the threshold.

7. The engine controller of claim 1, wherein the controller initiates a second deceleration cylinder cut off (DCCO) process wherein the DCCO process reduces flow of gas to the turbocharger and thereby the turbocharger rotational speed decreases toward the threshold.

8. A method, comprising:
determining a minimum threshold rotational speed for a turbocharger;
determining a target firing fraction that will allow the engine to maintain a turbocharger rotational speed above the threshold;
initiating a deceleration cylinder cut off (DCCO) process; and
ceasing the DCCO process when the turbocharger rotational speed reaches the threshold.

9. The method of claim 8, wherein the method further includes:
receiving speed data of the turbocharger rotational speed and analyzing the received data to determine when the rotational speed reaches the threshold.

10. The method of claim 8, wherein the method further includes:
receiving speed data of the turbocharger rotational speed;
analyzing the received data to determine when to switch the firing fraction of the engine from an original firing fraction to the determined target firing fraction to maintain the rotational speed of the turbocharger above the threshold; and
implementing the target firing fraction after the DCCO process has been ceased.

11. The method of claim 8, wherein receiving speed data of the turbocharger rotational speed includes receiving speed data stored in memory in the vehicle.

12. The method of claim 8, wherein determining the target firing fraction includes selecting the target firing fraction from a plurality of firing fractions stored in memory in the vehicle.

13. The method of claim 8, wherein the DCCO process includes reducing flow of exhaust to the turbocharger and thereby the turbocharger rotational speed decreases toward the threshold.

14. The method of claim 8, wherein initiating a deceleration cylinder cut off (DCCO) process includes initiating the DCCO process when a vehicle operator has no torque demands for the engine.

15. A turbocharger rotational speed management system, comprising:
an internal combustion engine in a vehicle;
a turbocharger connected to the internal combustion engine; and
an engine controller for controlling the internal combustion engine, the controller configured to:
determine a threshold rotational speed for the turbocharger;
determine a target firing fraction that will allow the engine to maintain a rotational speed above the threshold;
initiate a deceleration cylinder cut off (DCCO) process wherein the DCCO process decreases the turbocharger rotational speed;
receive speed data of the turbocharger rotational speed; and
analyze the received data to determine when to switch the firing fraction of the engine from an original firing fraction to the determined target firing fraction to maintain the rotational speed of the turbocharger above the threshold.

16. The turbocharger rotational speed management system of claim 15, wherein the system further includes a turbocharger rotational speed sensor to measure the rotational speed of at least one of: a turbine, a shaft, or a compressor wheel of the turbocharger.

17. The turbocharger rotational speed management system of claim 15, wherein the turbocharger is a variable geometry turbocharger (VGT) and wherein the VGT is adjusted to slow a decrease in the rotational speed of the turbocharger.

18. The turbocharger rotational speed management system of claim 15, wherein the turbocharger is a variable geometry turbocharger (VGT) and wherein the VGT is adjusted to accelerate an increase in the rotational speed of the turbocharger.

19. The turbocharger rotational speed management system of claim 15, wherein the turbocharger is a variable geometry turbocharger (VGT) having vanes that adjust to increase and decrease a volume of gas through the turbocharger.

20. The turbocharger rotational speed management system of claim 15, wherein the turbocharger is a variable geometry turbocharger (VGT) and wherein the engine controller selects a VGT configuration from a set of configurations stored in memory in a vehicle.
